(19) United States
(12) Patent Application Publication
(10) Pub. No.: US 2010/0302116 A1
(43) Pub. Date: Dec. 2, 2010

(54) MULTIPLE BAND COLLINEAR DIPOLE ANTENNA

(76) Inventors: Polsky Patrick, Guelph (CA); Duong Haitu, Guelph (CA)

Correspondence Address: MILLER THOMPSON, LLP, Scotia Plaza, 40 King Street West, Suite 5800, TORONTO, ON, M5H 3S1, CA

(21) Appl. No.: 12/749,045

(22) Filed: Mar. 29, 2010

(30) Foreign Application Priority Data
May 27, 2009 (CA) 2,666,896

(51) Int. Cl. H01Q 9/16; H01Q 21/12; H01Q 21/00

(52) U.S. Cl. 343/749; 343/812; 343/810

(57) ABSTRACT

A vertical dipole-style antenna operable over a wide range of predetermined frequencies that is made up of two collinear dipole antennas fed either in parallel through a single input connector or individually through two input connectors, contained within the same enclosure, where one dipole covers the VHF portion of the band from 30 MHz to 115 MHz and the other dipole covers the remainder of the band from 115 MHz to 512 MHz and together the two dipoles cover the very wide frequency band of 30 to 512 MHz through a single input connector. The VHF dipole is comprised of an existing vehicular dipole antenna design, while the UHF dipole antenna is comprised of radiating elements fed with a specially design coaxial transformer feedline with wide-band capacitive elements coupling the radiating elements to ground, providing variable loading to control the electrical length of the antenna.

### FIELD OF INVENTION

The invention relates to broadband antennas used in radio transmission and receiving systems. More particularly, this invention relates to dipole-style antennas having an instantaneous bandwidth between 30 MHz and 512 MHz which exhibits a low voltage standing wave ratio or VSWR of less than 3:1 and provides high transmission gain, while offering independence from proper ground planes. More particularly, this invention describes wideband, vertical dipole antennas of rugged construction so as to survive the harsh environmental conditions commonly found in, although not limited to, vehicular military applications. Furthermore, this invention relates to wideband antennas utilising either a single input or a dual input to create a single antenna capable of covering multiple sub-bands encompassed within the entire frequency range of 30 MHz to 512 MHz.

### BACKGROUND OF THE INVENTIONS

It is known that broadband antennas have been developed and used for a wide range of communications applications. Between government, military, commercial and amateur users, broadband antennas have become quite common. However, these antennas are still only limited to specific sub-bands of use; for example, the HF band of 2 MHz to 30 MHz, or the VHF band of 30 MHz to 108 MHz, or the UHF band of 225 MHz to 400 MHz or any of the sub-bands in between. With all these different frequency bands, different radio equipment is required and, as such, different antennas are required to cover these ranges.

Dipole antennas at their most basic description are similar to monopole antennas in that they are typically narrow band entities. However, the dipole antenna is generally preferred because it exhibits a higher gain than the monopole and is not as dependant on a proper ground plane. However, the higher gain is not without is consequences. Theory dictates that dipole antennas should typically be twice as high as monopole antennas. Specifically, half a wavelength of the operating frequency for a dipole versus only a quarter wavelength for a monopole. However, practice shows that an electrically short dipole can be designed without a great loss in performance. Thus, an ideal antenna has high gain, reduced height, very wide bandwidth and can be operated effectively with or without a proper ground plane.

The prior art show numerous devices and methods which try to produce such results but have not exhibited all these attributes. For example, there are monopole antenna designs which provide medium gain and good height but just have a bandwidth of 30 MHz to 108 MHz. There are also dipole antenna designs which provide good gain and good height but again only a bandwidth such as 30 MHz to 108 MHz or even 225 MHz to 400 MHz. Another arrangement relates a monopole antenna that offers good height and claims good gain over the extremely wide bandwidth of 30 MHz to 512 MHz. However this other arrangement does not relate to a dipole antenna.

Up until now, there have been many developments to widen the effective bandwidth of both monopole and dipole antennas. Some of these include adding traps in strategic locations on the radiating elements to create multiple resonance frequencies. Increasing the diameter of the conductors or using what is known as sleeves will provide modest improvements to gain and bandwidth. Also, using a transmission line transformer approach where a transmission line, made up of a twisted pair or a coaxial cable, is wound around a core, often of a magnetic material, in order transform the impedance of the antenna, thus matching it to the transmission line over a set of frequencies. This method has been found to be quite successful in the past to provide antenna designs to cover the major bands of 2 MHz to 30 MHz, 30 MHz to 108 MHz, 115 MHz to 175 MHz, 225 MHz to 400 MHz, etc. However, they were still limited in their abilities to match larger bandwidths without introducing increased losses into the design.

A specific prior art antenna is shown in U.S. Pat. No. 4,097,870 which discloses an apparatus forming at least a portion of an antenna and the method of constructing the same. A generally cylindrical casing is formed to hold a spacer having a generally cylindrical outer surface. The spacer has a generally axial aperture extending therethrough to receive an antenna transmission line so that the line will be spaced from the outer surface of the spacer and the casing. An antenna wire is braided around the outer surface of the spacer to locate the same between the spacer and the casing.

Another antenna is shown in U.S. Pat. No. 4,229,743 which includes three impedance elements. The second impedance element, which may also be called a network, includes a coil and at least one other conductor in operative association therewith. The second impedance element may be electrically connected to both a first impedance element, which may include a linear conductor coupled to a radio and a third impedance element which may include a coil.

U.S. Pat. No. 4,890,116 discloses a low-profile, broad band monopole antenna which includes two linear radiators, a resistor network and a transmission line network, all connected in series in that order.

U.S. Pat. No. 4,958,164 teaches a low-profile, broad band monopole antenna which includes two linear radiators, a resistor network and a transmission line network, all connected in series in that order. Linear radiator includes a capacitor, which reduces the apparent electrical length of the antenna and provides high voltage isolation. Resistor network reduces VSWR at lower frequencies in the band of interest such that in combination with the other elements, the VSWR for antenna is sufficiently low that no further matching or tuning is necessary over the entire broad frequency band of interest without significant loss of gain relative to that of a monopole antenna one-quarter wave resonant at each frequency throughout the frequency band of interest.

Furthermore U.S. Pat. No. 6,429,821 shows an antenna operable over a predetermined range of frequency and includes a transmission line, a transformer network connected to one end of the transmission line, and at least one inductor-resistor network connected to an opposite end of the transformer network.

Moreover, U.S. Pat. No. 6,836,256 shows a wideband antenna system capable of radiating or receiving signals in a low-frequency band [Fbb, Fbh] covering more than one octave and a high-frequency band [Fhb, Fhh] with Fhb>=2Fbh comprising at least one power supply device powering at least one upper radiating element and at least one lower radiating element.

U.S. Pat. No. 6,985,121 illustrates a multiband antenna having a lower conductive tube and three or more upper conductive tubes, all spaced from each other and disposed on the same longitudinal axis.

Another arrangement is shown in U.S. Pat. No. 5,977,920 which relates to an antenna which comprises a single-pole antenna for low frequencies surmounted by a dipole type antenna for high frequencies. The supply cable of the dipole antenna has an external conductor used to form the single-pole antenna above the ground plane. Beneath the ground plane, this external conductor is wound in turns to constitute the secondary winding of a transformer for the supply of the single-pole antenna.

### SUMMARY OF THE INVENTION

The present invention relates to a dipole antenna with an extremely wide bandwidth capable of operating over multiple “standard” operational bandwidths, such as 30 MHz to 512 MHz, that is also vertically low in height and provides low instantaneous VSWR across the band while still maintaining good gain characteristics and does not require a proper ground plane.

It is an object of this invention to provide an antenna comprised of two collinear dipole antennas, essentially fed in parallel through a single input connector. The two dipoles can be divided and classified as a VHF dipole to cover the frequency range of 30 MHz to 115 MHz and a UHF dipole to cover the frequency range of 115 MHz to 512 MHz.

It is a further object of this invention to provide an antenna to be built of a rugged design to survive the harsh environmental conditions present in military, vehicular applications as well as providing safety and ease of use to the end-user.

The VHF dipole can be any vehicular, vertical dipole antenna, which in the case of this invention, the VHF antenna is based on a pre-existing, two-piece construction antenna design where a coaxial feedline cable runs up the inside of the lower radiating element tube and feeds an unbalanced-to-balanced matching network comprised of a ferrite rod with bifilar windings, capacitors and coaxial tuning stubs. This matching network feeds the two radiating elements. An integral series capacitor located within the top element has high enough capacitance so that it does not effect the antenna electrically but also has a high enough voltage rating to provide DC and low frequency isolation in the case of accidental striking of overhead powerlines. An integral RF choke and surge arrester located near the bottom of the lower element provides EMI and EMP protection.

The UHF dipole is comprised of a rigid coaxial transmission-line transformer running up the inside of the upper and lower radiating elements, feeding the centre of the dipole from the input connector. The characteristic impedance of the feed is varied to provide some matching. A second tube running up the centre of the upper and lower radiating elements serves as a DC ground connection at the two outside ends of the antenna and also serves as a feed through tube for the additional coaxial feedline through this antenna, connecting the VHF whip to the input connector. Capacitive elements located at the two extreme ends of the dipole antenna are connected to the grounded feed-through tube to provide additional matching and coupling to ground. Overall tuning of the antenna is accomplished through a combination of specific element dimensions, optimised coaxial transformer techniques for the feedline and strategic placement of the capacitive elements on the radiating elements.

It is an aspect of this invention to provide an antenna comprised of two collinear dipoles, housed within a non-conductive envelope, that are interconnected so as to be operable over a wide bandwidth, of 30 MHZ to 512 MHz, with a VSWR of less than 3:1 over more than 90% of said band and not exceeding 3.5:1.

It is a further aspect of this invention to provide an antenna operable over a wide frequency range comprising two collinear dipole antennas substantially fed in parallel through a single input connector.

Yet another aspect of this invention relates to a method of transmitting and receiving signals through an antenna operable over a frequency of about 30 MHz to 512 MHz comprising the collinear placement of a UHF dipole antenna, with a VHF dipole antenna within a non-conductive envelope, where the UHF dipole antenna has at least two tubes; placing a first cable through one of said tubes; and placing a second cable through said second tube to feed said VHF dipole antenna.

### BRIEF DESCRIPTION OF THE DRAWINGS

These and other objects and features of the invention shall now be described in relation to the following drawings:

FIG. 1 is an elevation view in perspective with partial cross-sectional views representing one example of the preferred embodiment of the complete multiple band dipole antenna design.

FIG. 2a is an elevation view in perspective with additional partial cross-sectional views of the complete antenna, detailing the individual VHF dipole and UHF dipole antennas within the design.

FIG. 2b is an elevation view in perspective with partial cross-sectional views of the lower portion of the antenna. It has been zoomed-in slightly to detail the UHF dipole portion of the antenna design.

FIG. 2c is an elevation view in perspective with partial cross-sectional views of the upper portion of the antenna. It has been zoomed-in slightly to detail the VHF dipole of the antenna design.

FIG. 3 is an example of a capacitive element design as used in the current invention.

FIG. 4 is an elevation view in perspective detailing the optional dual input connector configuration.

FIG. 5 is a VSWR plot of the UHF dipole portion of the antenna design alone covering the frequency range of 115 MHz to 512 MHz.

FIG. 6 is a VSWR plot of the complete multiple band antenna design covering the frequency range of 30 MHz to 512 MHz.

### PREFERRED EMBODIMENT OF THE INVENTION

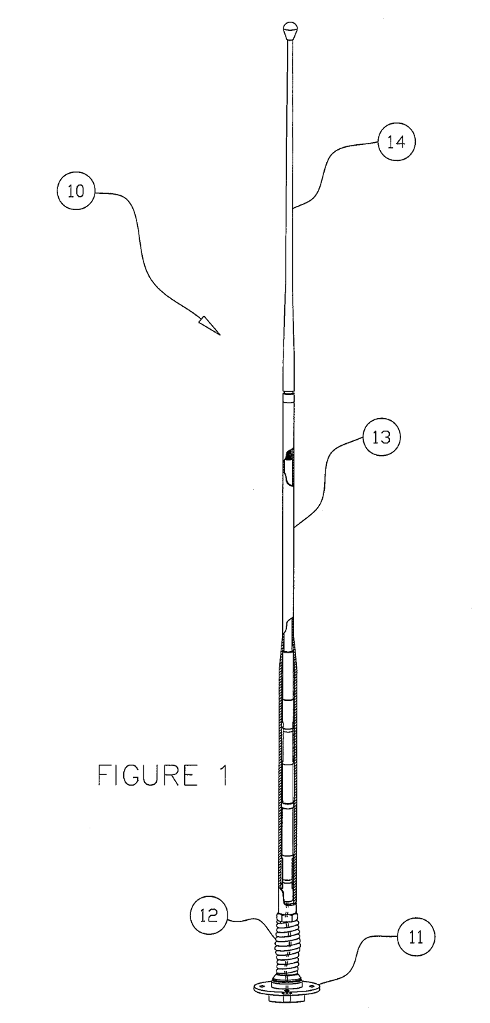

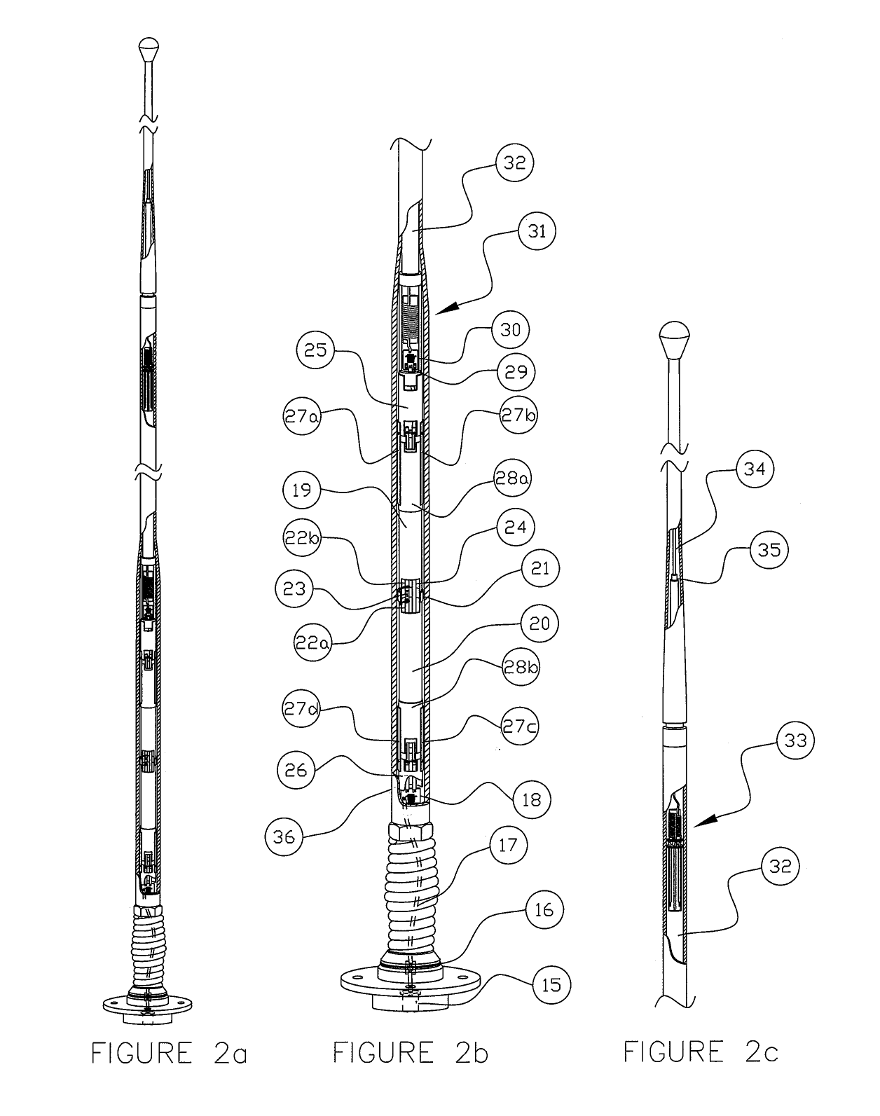

Referring to FIGS. 1 through 4, the typical multiple band dipole antenna is depicted by the numeral 10. The antenna 10, as a whole, is comprised of a base flange 11, a lower whip section 13 (with integral spring mount) and an upper whip section 14. The base flange 11 is comprised of an aluminum base support, which is mountable to any flat, rigid surface through the use of common hardware, and a large female threaded hole. The integral spring mount, preferably built of a corrosion resisting steel wire is mechanically fastened to the lower whip section 13. The lower whip section 13 contains the UHF dipole and the lower half of the VHF dipole. It has a threaded ferrule at the top to mate to the upper whip section 14. The upper whip section contains the upper half of the VHF dipole. The upper and lower whip sections of the multiple band dipole antenna are enclosed within a rugged, non-conducting envelope 36 preferably of a fibreglass cloth, embedded with an epoxy resin.

In one such embodiment, the integral spring mount is designed in such a way to accept a single RF connector 15 to carry a signal into an attenuator pad 16. The attenuator pad provides a maximum of 1 dB attenuation and assists with maintaining the VSWR across more than 90% of the band below 3:1, assuring substantial protection against damaging reverse power levels into the transmitting equipment ports with negligible affect on antenna gain performance. From the attenuator pad output a typical 50Ω coaxial cable 17 runs up the inside of the flexible spring to a filter pad 18. At this point, the signal is combined/split into two paths 18, one for the UHF dipole and the other for the VHF dipole.

In another such embodiment, the integral spring mount is designed in such a way to accept two RF connectors 37 to carry the signal into two separate attenuator pads 38. From the attenuator pads, separate coaxial cables 39 run up the inside of the spring to a filter pad 40. At this point, the signal is isolated from either channel and carried into the respective VHF and UHF antennas.

The UHF dipole is contained within the lower end of the lower whip section and is comprised of two main elements 19 and 20 made up of brass tubing with a diameter of 0.9 inches and a wall thickness of 0.03 inches. An insulating disc 21 separates the two elements and physically supports the structure. Centrally located through the centre of the elements are two smaller brass tubes, each with a diameter of 0.15 inches and a wall thickness of 0.012 inches and running the full lengths of the elements. One tube, which will be called the feedline tube 22a and 22b, is broken at its centre, where it runs through the insulating disc.

The two ends of the broken feedline tube which meet at the centre insulating disc are then electrically connected to the two ends of the adjacent element tubes. Inside the feedline tube, lies a conductor covered in an insulating material 23 so as to create a coaxial cable with a capacitive characteristic impedance. The diameter of the feedline's centre conductor is varied to create sections of differing impedances. The value of the impedances, order and quantity of the sections are intricately selected to provide maximum signal transfer from the centre conductor to the two pieces of the feedline tube. The end of the centre conductor is left isolated from the feedline tube so that a DC open circuit state exists between the input signal line and either of the two UHF dipole radiating elements. Signal energy is transferred to the feedline tube sections which are then directly connected to the upper and lower radiating elements.

The second tube, which will be called the feed-through tube 24, has two functions. The first function is to provide a means of passing a second coaxial cable 30 through the UHF dipole antenna, without interfering with the RF signal flow, providing the input feed to the VHF dipole antenna. The second function of the feed-through tube is to provide a means of creating a ground potential connection from the input connector's ground connection to the ground rings located at the top of the upper element 25 and at the bottom of the lower element 26 of the antenna. Connected to the ground rings are the capacitive elements 27 which resemble a number of fingers protruding down from the ring and laying over the radiating element.

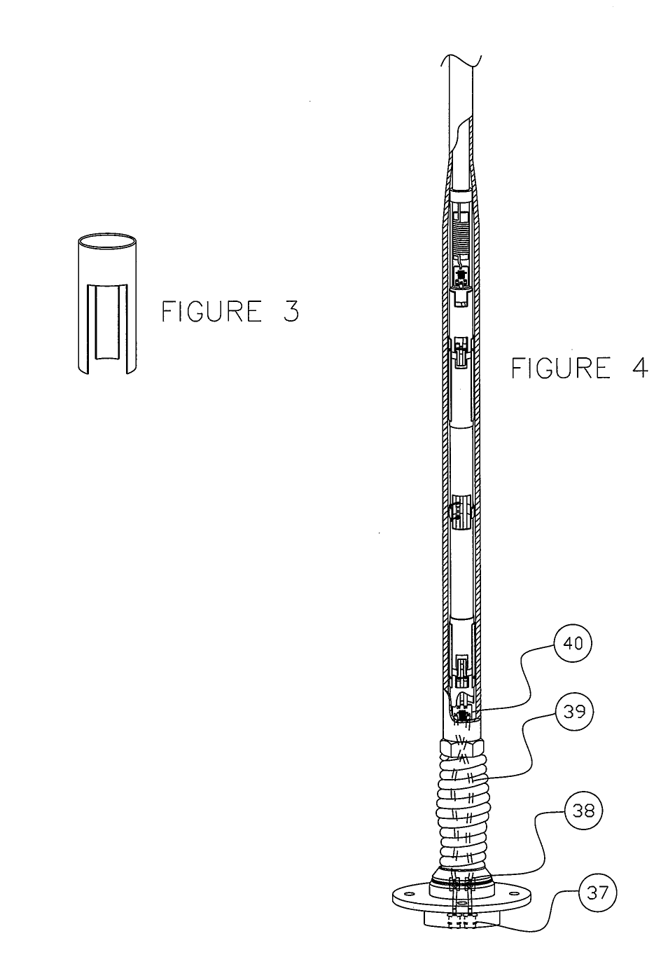

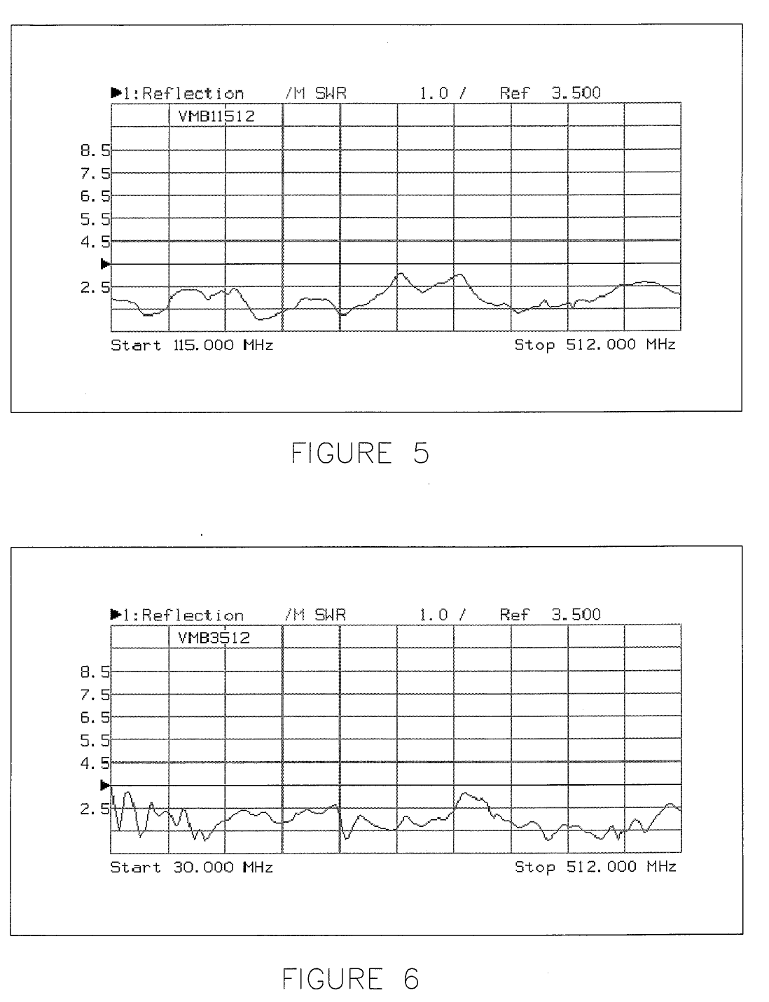

The number of, width of and length of the fingers are related to the wavelength of the desired operating frequency and the extent of capacitance required to provide maximum impedance matching for the range of frequencies desired. It is important to note that the exact design and configuration of the capacitive elements used in this invention can be adjusted to fit the needs of the specific product. For example, FIG. 3 depicts such a structure, which is slightly different in construction to that described above. Also, where there is enough physical room, this invention allows for the placement of the capacitive elements to be located at the centre of the antenna where the feed point is located, coupling the upper and lower radiator together. Between the fingers and the radiating elements is an insulating sheet 28 that serves as the dielectric material of the capacitive structure. When dealing with the higher frequencies, the fingers play an important role in that they provide a form of wideband capacitive end-loading, which varies the electrical length of the radiators with respect to frequency. The open spaces between the fingers still allows for maximum radiation from the elements.

Returning to the split input cable 18, a second straight 50Ω coaxial cable is run up through the feed-through tube 24, passes into an integral filter network 30, then an RF choke 31 and finally up through the inside of the lower element of the VHF dipole 32 to feed the matching network 33. The filter network 30 is a 4^{th} order low-pass filter with a cut-off frequency of about 110 MHz. The purpose of the filter is to block the frequencies greater than 110 MHz from travelling up into the VHF antenna. The reason for needing the filter is due to the design of the matching network in the VHF dipole. At the higher RF frequencies, the matching unit appears as a high impedance so the coaxial cable feeding the matching unit appears as an open-circuit stub. Since the length of the coaxial cable is roughly equal to ½-wavelength at 130 MHz, unwanted standing waves are created which interfere with the impedance matching abilities of the UHF dipole antenna. The RF choke 31 is there to help suppress EMI interference and any other high frequency components picked up by the antenna from traveling back into the transceiver equipment.

The VHF dipole antenna design is contained within the upper half of the lower whip section 13 and the upper whip section 14. Any VHF whip dipole antenna can be used with this antenna design as long as it covers 30 MHz to 115 MHz with the ability for slight tuning adjustment and can be mechanically combined in a reliable, safe and easy-to-use manner. In the particular embodiment of the invention described, the VHF dipole is comprised of a matching network 33, further comprised of a ferrite rod, unbalanced-to-balanced transformer, with capacitors, surge suppressors and coaxial tuning stubs, shorted to appear as inductors, feeding the upper element 34 and lower element 32. As with most vehicular antenna designs, the upper element contains an integral high voltage capacitor 35 to protect the user against accidental strikes of overhead powerlines.

The foregoing is a detailed description of one embodiment of the invention which is given here by way of example only. The invention is not to be taken as limited to any of the specific features as described, as it will be appreciated by those skilled in the art that variations may be made thereto without departing from the spirit of the invention or scope of the appended claims.

What is claimed:

1. An antenna comprised of two collinear dipoles, housed within a non-conductive envelope, that are interconnected so as to be operable over a wide bandwidth, of 30 MHZ to 512 MHz, with a VSWR of less than 3:1 over more than 90% of said band and not exceeding 3.5:1.

2. The antenna as claimed in claim 1 comprising a UHF dipole antenna operable over 115 MHz to 512 MHz.

3. The antenna as claimed in claim 2 wherein said UHF dipole antenna comprises large diameter radiating elements that are physically short compared to a ¼-wavelength of the lowest operating frequency, with two tubes mounted centrally up the length of the antenna, where the one tube acts as part of the feedline to the antenna and the other tube acts as a ground connection to both ends of the antenna and to allow a second coaxial cable to be run through the antenna to feed a second antenna.

4. The antenna as claimed in claims 2 and 3 further including a coaxial transformer feedline and one or more capacitive elements, coupling either one or both radiating elements to ground, thus creating a variable capacitive load to control the effective length of the antenna.

5. The antenna as claimed in claim 1 further including a VHF dipole antenna operable over a wide frequency range of 30 MHZ to 115 MHz.

6. The antenna as claimed in claims 2 and 5 mounted in the same axis to create a collinear array with feedlines connected in parallel so as to create a single input and a low-pass filter on the input of the VHF portion in order to control the UHF standing waves.

7. An antenna operable over a wide frequency range comprising two collinear dipole antennas substantially fed in parallel through a single input connector.

8. The antenna of claim 7 wherein one of said dipole antennas comprises a UHF dipole antenna.

9. The antenna of claim 8 wherein said UHF dipole antenna is operable over a frequency of about 115 MHz to 512 MHz.

10. The antenna of claim 9 wherein said UHF dipole antenna further comprises at least two tubes mounted centrally up a length of the UHF dipole antenna, where one of the tubes receives a first cable to the antenna and the other tube operates as a ground connection to both ends of the antenna, and to receive a second cable to feed the second dipole antenna.

11. The antenna of claim 10 wherein the first cable comprises a conductor covered in an insulating material to define a first coaxial cable with a capacitive characteristic impedance.

12. The antenna of claim 11 wherein the first coaxial cable has a diameter that varies along its length to present sections of different impedances.

13. The antenna of claim 12 where an end of the first coaxial cable is isolated from the one of the tubes so that a DC open circuit exits between an input signal line and the UHF dipole antenna having two UHF dipole radiating elements.

14. The antenna of claim 13 wherein the second tube provides a means of passing the second cable through the UHF dipole antenna without interfering with RF signal flow so as to provide an input feed to the second dipole antenna.

15. The antenna of claim 14 wherein said second dipole antenna comprises a VHF dipole antenna.

16. The antenna of claim 15 wherein the VHF antenna is operable over a frequency range of about 30 MHz to 115 MHz.

17. The antenna of claim 7 further having isolated fees so as to present a dual input antenna including at least one capacitive element.

18. The antenna of claim 17 wherein the capacitive element comprises a ring and a plurality of fingers protruding therefrom.

19. A method of transmitting and receiving signals through an antenna operable over a frequency of about 30 MHz to 512 MHz comprising the collinear placement of a UHF dipole antenna, with a VHF dipole antenna within a non-conductive envelope, where the UHF dipole antenna has at least two tubes; placing a first cable through one of said tubes; and placing a second cable through said second tube to feed said VHF dipole antenna.

20. A method as claimed in claim 19 including at least one capacitive element.
